(19) United States
(12) Patent Application Publication
(10) Pub. No.: US 2012/0119919 A1
(43) Pub. Date: May 17, 2012

(54) MULTIFUNCTIONAL TORQUE DETECTION DEVICE

(75) Inventor: CHIANG KAO CHEN, TAIPEI HSIEN (TW)

(73) Assignee: LEGEND LIFESTYLE PRODUCTS CORP., TAIPEI (TW)

(21) Appl. No.: 12/946,270

(22) Filed: Nov. 15, 2010

(51) Int. Cl. G08B 21/00; G01L 3/00

(52) U.S. Cl. 340/665; 702/42

(57) ABSTRACT

A multifunctional torque detection device includes a toque-strain bar enclosed by an enclosure and having opposite ends respectively forming coupling terminals for coupling with an adaptor and a coupler in either direction. The adaptor is connectable to a torque device, such as a hand tool, an electric tool, or a pneumatic tool. The coupler is connectable to a tool piece, such as a wrench socket. A strain gauge is directly mounted to the toque-strain bar to detect a torque applied thereto and to convert the torque into a torque value signal. An angle sensor is mounted inside the enclosure to detect a horizontal angle of the torque-strain bar and the enclosure and to convert the detected angle into an angle value signal. Both signals can be outputted in either wired or wireless manner. The information display unit is mounted to the enclosure and is coupled to the strain gauge and the angle sensor to receive the torque value signal and the angle value signal, whereby the information display unit may perform displaying of torque and angle values, alarming, and storage according to the torque value signal and the angle value signal.

### BACKGROUND OF THE INVENTION

1. Field of the Invention

The present invention relates to a multifunctional torque detection device, and in particular to a detection device that is connectable with various torque devices and tool pieces in opposite directions for performing detection, transmission, displaying, alarming, and storage of an actual value of torque applied thereto and an angle value of operation orientation.

2. The Related Arts

A hand tool, electrical tool or pneumatic tool, such as a wrench socket or a spanner, is widely used in assembling and maintenance operations of mechanical engineering for tightening or loosening threaded fasteners, such as nuts and bolts, attached to a machine or a mechanical part. However, for high precision machinery, the nuts or bolts must be tightened or loosened by following predetermined operation processes with preset levels of torques. Improper operation of a hand tool, an electrical tool, or a pneumatic tool to apply a torque may inadvertently cause damage or breaking of a threaded fastener or a threaded hole, and may thus lead to undesired damage to the functionality and operation precision of the machine. The conventional hand tools, electric tools, or pneumatic tools are not capable of detecting and displaying the value of a torque applied in an operation, whereby a user cannot get aware of the level of torque applied and must thus depend on his or her experience and discretion to operate the hand tool or electric or pneumatic tool. This may lead to improper application of torque due to human errors.

Further, a torque wrench often needs to be held in a particular horizontal angle in the operation thereof. If the wrench or the wrench socket is not set at a desired proper horizontal angle, a bolt or a nut that is being tightened may be damaged by breaking the thread thereof. Heretofore, a skilled operator relies completely upon his or her experience and effective management and alarm may not be realized

On the other hand, if each hand tool, electric tool, or pneumatic tool is individually provided with a specific torque detector in order to provide torque detectable hand tool, electric tool, or pneumatic tool, then the costs for design and manufacture of the tools must be greatly increased, and this arrangement may not be feasible for all applications where hand tools, electrical tools, and pneumatic tools are used to apply a torque to a workpiece.

Other prior art references in this field are also known. For example, Taiwan Patent No. 1300027 discloses a torque wrench having a driving head that is provided with a torque display device, and Taiwan Patent No. 1307305 discloses a digital alarm device for torque wrenches. Both Taiwan patents illustrate conventional solutions that mount displaying or alarming devices for torque detection to torque wrenches for the purposes of detection of torque. However, in such known solutions, mounting the torque detection and displaying device to the torque wrench is a difficult operation and this makes the manufacturing of the torque wrench very complicated. Further, both patents provide a solution of torque detection that is only applicable to specific torque wrenches and is not suitable for all kinds of hand tools, electrical tools, and pneumatic tools.

Other prior art references include Taiwan Utility Model No. M367059, which discloses an extender device with a display unit (30) mounted thereto. The extender device comprises an extension bar (10) having two ends forming first and second coupling sections (11, 12) respectively. The first and second coupling sections (11, 12) and the digits displayed on a display panel (313) of the display unit (30) are arranged for only a specific direction of use. In other words, a user must distinguish the first coupling section (11) from the second coupling section (12) before he or she can use connect the extender device to a working head (2) of a torque tool (1) and an associated socket (3), which can only and respectively connect to the second coupling end (12) and the first coupling section (11) and cannot switch with each other. Besides such inconvenience occurring in using the extender device, when the torque tool is set at a given direction, such as the socket (3) being pointed downward, the digits displayed on a display panel (313) of the display unit (30) is visually observable and identifiable, but when the torque tool is set at an opposite direction, such as the socket (3) being pointed upward, the orientation of the digits on the display panel (313) is reversed, making it difficult for a user to read the digits.

In addition, Taiwan Utility Model No. M377299 discloses an angle-measureable torque tool coupler, wherein a torque wrench having a conventional construction is provided with torque/horizontal angle detection, displaying, and alarming for the purposes of realizing detection of torque and angle. However, such a device is only good for personal use in detecting, displaying and issuing alarms associated with torque and horizontal angle. It is not possible for a large workshop to provide centralized control and management in respect of the use of a large number of torque wrenches. Thus, economic advantages gained through collective and consistent control and management of the use of torque wrenches cannot be realized.

### SUMMARY OF THE INVENTION

In the known torque wrench provided with torque displaying and the up-to-date technology, each individual extension bar is only fit for a particular size of torque tool and socket and is only workable for detection of torque and angle for tools of specific sizes, leading to unacceptable economic problems. In addition, the mode of the operation of the display unit only allows for visual access of torque and angle readings in a specific direction, making the user and operation inconvenient in reading the torque value and angle value. Further, the sensor of the extension bar and the display unit are connected through wires, which prevent use of the extension bar and the display unit in a separated manner.

To overcome the problems and drawbacks of the conventional devices, the present invention provides a multifunctional torque detection device, which comprises a toque-strain bar enclosed by an enclosure and having opposite ends respectively forming coupling terminals for coupling with an adaptor and a coupler in either direction. The adaptor is connectable to a torque device, such as a hand tool, an electric tool, or a pneumatic tool. The coupler is connectable to a tool piece, such as a wrench socket. At least one strain gauge, preferably a dual-slope-piece strain gauge, is directly mounted to the toque-strain bar to detect the value of a torque applied thereto and to convert the torque value into a torque value signal. At least one angle sensor is coupled to the enclosure to detect the value of a horizontal angle of the torque-strain bar and the enclosure and converts the angle value into an angle value signal. The torque value signal and the angle value signal are outputted in either wired or wireless manner. An information display unit, which is mounted to the enclosure and contains pre-established alarm thresholds for torque and horizontal angle, is coupled to the strain gauge and the angle sensor, whereby the information display unit may perform displaying of torque value and angle value, alarming, and storage according to the torque value signal and the angle value signal.

Further, the strain gauge and the angle sensor of the multifunctional torque detection device of the present invention are connected to at least one wireless data transmitter module that allows the torque value of the toque-strain bar detected by the strain gauge and the angle value detected by the angle sensor to be transmitted in a wireless manner. The information display unit comprises at least one wireless data receiver module that receives the torque value of the toque-strain bar and the angle value transmitted from the wireless data transmitter module in a wireless manner in order to supply the torque value and the angle value to the information display unit for displaying.

The effectiveness of the multifunctional torque detection device of the present invention is that an adaptor and a coupler are provided for mating and connection with torque tools, such as hand tools, electric tools, and pneumatic tools of various specifications and tool pieces of various sizes, so that constraint to the application of the multifunctional torque detection device is removed. In addition, the coupling terminals of the toque-strain bar are not subjected to the direction of coupling and allow each of the adaptor and the coupler to be coupled thereto in either direction, so that a torque tool, such as a hand tool, an electric tool, or a pneumatic tool, and a tool piece, such as a wrench socket, can be conveniently coupled from either direction to facilitate the operation and application thereof. Such a mechanism of coupling to either coupling terminal of the toque-strain bar in either direction allows the information display unit to be properly positioned without the problem that the conventional extender device limits the display unit to be set at only a given direction; otherwise the data displayed cannot be properly read. Thus, the information display unit of the present invention can always be readily read no matter whatever direction at which the torque tool, such as a hand tool, an electric tool, or a pneumatic tool, and a tool piece is set may be.

Further, transmission and reception of data between the stain gauge and the angle sensor and the information display unit can also be done in a wireless manner with a wireless data transmitter module and a wireless data receiver module, whereby the adaptor and the coupler coupled to the ends of the toque-strain bar and the torque tool, such as hand tool, electric tool, or pneumatic tool, and the tool piece, such as wrench socket, respectively connected thereto can be operated without being constrained by the space or orientation of operation and problems of wire entangling or wire breaking can be eliminated. As such, the industrial value and operation performance of the multifunctional torque detection device can be improved.

### BRIEF DESCRIPTION OF THE DRAWINGS

The present invention will be apparent to those skilled in the art by reading the following description of preferred embodiments thereof, with reference to the attached drawings, wherein:

FIG. 1 is a perspective view showing a multifunctional torque detection device constructed in accordance with a first embodiment of the present invention;

FIG. 2 is also a perspective view of the multifunctional torque detection device in accordance with the first embodiment of the present invention, but taken at a different perspective;

FIG. 3 is an exploded view of the multifunctional torque detection device in accordance with the first embodiment of the present invention;

FIG. 4 is a block diagram of an information display unit of the multifunctional torque detection device in accordance with the first embodiment of the present invention;

FIG. 5 is a perspective view showing a multifunctional torque detection device constructed in accordance with a second embodiment of the present invention;

FIG. 6 is an exploded view of the multifunctional torque detection device in accordance with the second embodiment of the present invention shown in FIG. 5;

FIG. 7 is a block diagram of an information display unit of the multifunctional torque detection device in accordance with the second embodiment of the present invention shown in FIG. 5;

FIG. 8 is a perspective view illustrating an application of the multifunctional torque detection device of the present invention;

FIG. 9 is an exploded view of FIG. 8;

FIG. 10 is a perspective view illustrating another application of the multifunctional torque detection device of the present invention;

FIG. 11 is an exploded view of FIG. 10; and

FIG. 12 is a perspective view showing a multifunctional torque detection device constructed in accordance with a third embodiment of the present invention.

### DETAILED DESCRIPTION OF THE PREFERRED EMBODIMENTS

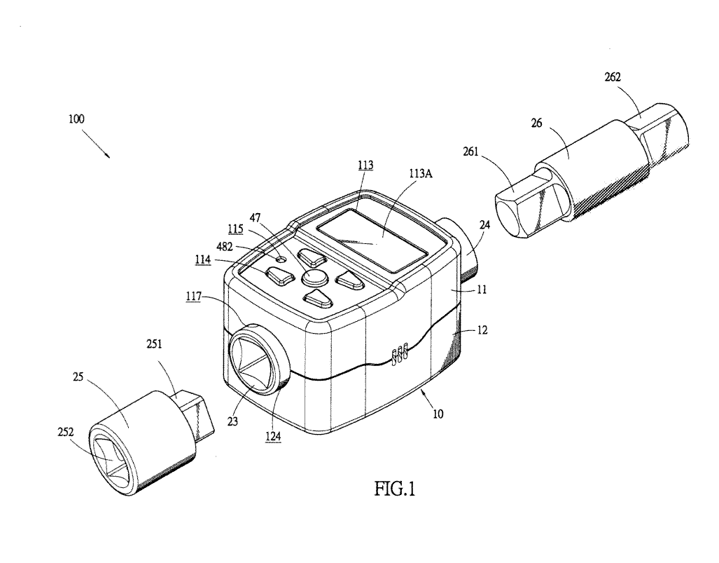

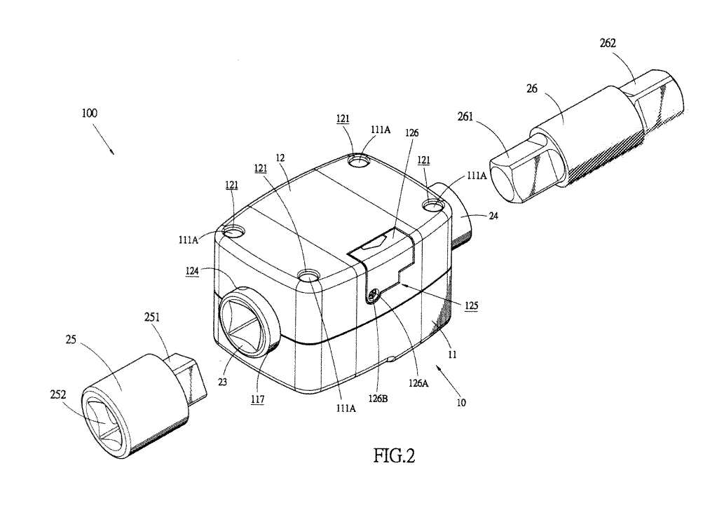

With reference to the drawings and in particular to FIGS. 1-3, a multifunctional torque detection device constructed in accordance with a first embodiment of the present invention is shown at 100. The multifunctional torque detection device 100 comprises an enclosure 10, which is composed of a first casing member 11 and a mated, second casing member 12. The first casing member 11 forms a plurality of mounting pillars 111 therein, and the second casing member 12 defines a plurality of mounting holes 121 corresponding to and mating the mounting pillars 111 to respectively receive bolts 111A to extend therethrough for fixing the first casing member 11 and second casing member 12 together.

The first casing member 11 defines an internal chamber 112 and the first casing member 11 also forms a display window 113, a plurality of button openings 114, and an alarm opening 115 in a top wall thereof. The display window 113 is an opening to which a transparent panel 113A is mounted. The first casing member 11 has opposite side walls, in which notches 116, 117 are respectively defined.

The second casing member 12 defines an internal chamber 122, in which two pairs of opposing support plates 122A, 122B are formed. The second casing member 12 has opposite side walls, in which notches 123, 124 are respectively defined to correspond to the notches 116, 117 of the first casing member 11, The second casing member 12 also forms on a bottom thereof a power compartment 125, in which two electrode plates 125A, 125B are mounted. The electrode plate 125A has an end that defines a mounting hole 125A′ for receiving a bolt 125C that secures the electrode plate 125A in the power compartment 125. The power compartment 125 also forms a threaded hole 125D, The power compartment 125 is covered and closed by a lid 126. The lid 126 defines a through hole 126A that corresponds to the threaded hole 125D. A bolt 126B extends through the through hole 126A and engages the threaded hole 125D to secure the lid 126 to the power compartment 125.

At least one toque-strain bar 20 is provided. The toque-strain bar 20 has a circumferential surface in which at least two pairs of opposite slots 21, 22 are defined to respectively receive the support plates 122A, 122B located in the internal chamber 122 of the second casing member 12 to fit therein so as to fix the toque-strain bar 20 between the support plates 122A, 122B. The toque-strain bar 20 has opposite ends, respectively forming a coupling terminal 23 and a coupling terminal 24. The coupling terminal 23 is received through the notch 117 defined in a side wall of the first casing member 11 and the notch 124 of the second casing member 12, while the coupling terminal 24 is received through the notch 116 defined in a side wall of the first casing member 11 and the notch 123 of the second casing member 12. The coupling terminals 23, 24 are not limited to any specific configuration and type and in an embodiment of the preset invention, both coupling terminals 23, 24 define therein a recessed coupling bore having a square shape, but it is apparent that coupling borers of other shapes are also applicable and deemed within the scope of the present invention,

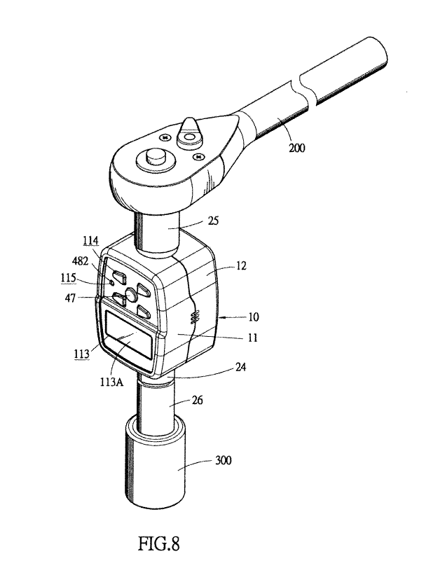

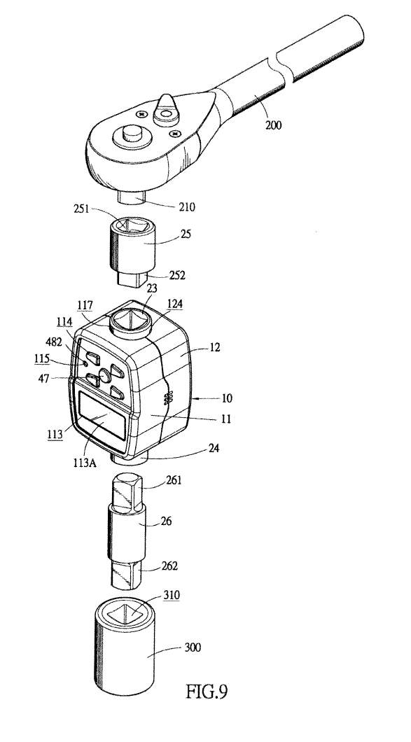

At least one adaptor 25 is provided, The adaptor 25 has opposite ends respectively forming a first raised coupling section 251 and a recessed coupling cavity 252. The first raised coupling section 251 is configured to couple with either one of the coupling terminals 23, 24 of the toque-strain bar 20. The recessed coupling cavity 252 is connectable to a tool coupling end 210 of a torque device 200 (see FIGS. 8 and 9). The configuration and size of the recessed coupling cavity 252 can be made to be fit for tool coupling ends of torque devices 200 of different specifications.

At least one coupler 26 is provided. The coupler 26 has opposite ends respectively forming a second raised coupling section 261 and a third raised coupling section 262. The second raised coupling section 261 is configured to couple with either one of the coupling terminals 23, 24 of the toque-strain bar 20. The third raised coupling section 262 is connectable to a fitting bore 310 of a tool piece 300 (see FIGS. 8 and 9). The configuration and size of the third raised coupling section 262 can be made to be fit for fitting bores of tool pieces 300 of different specifications.

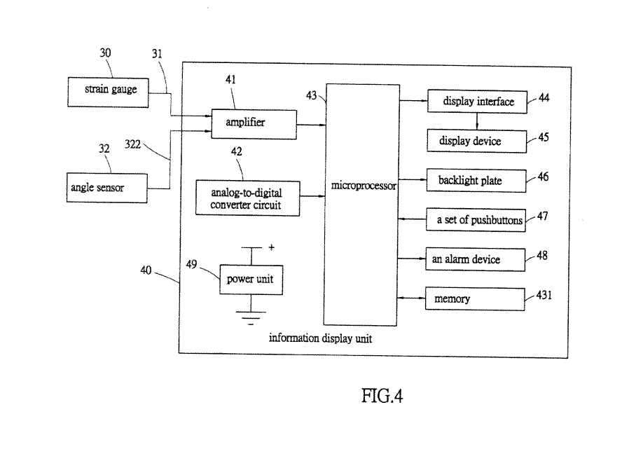

At least one dual-slope-piece strain gauge 30 is provided. The strain gauge 30 comprises electronic components that perform detection of torque through stress induced deformation. An example is the dual-slope-piece strain gauge of series CF350 available from Loadcell Technology Co., Ltd. located in Xiamen, China. The strain gauge 30 is directly coupled to a cylindrical surface of the toque-strain bar 20 to detect the value of a torque applied to the toque-strain bar 20 and converts the detected torque value into an output of a torque value signal 31 (see FIG. 4).

At least one angle sensor 32 is provided. The angle sensor 32 is mounted to a circuit board 321, which is in turn mounted to an outside surface of one of the support plates 122A. The angle sensor 30A is not limited to any specific form and a gyro integrated circuit bearing a model number ISZ-650 of Invensense series available from Macnica Taiwan Limited is taken as an example herein. The angle sensor 30A functions to detect the value of a horizontal angle at which the enclosure 10 and the torque-strain bar 20 are set and to convert the detected angle value into an output of an angle value signal 322 (see FIG. 4).

Referring to FIG. 4, an information display unit 40 is connected to the strain gauge 30 and the angle sensor 32 to receive the torque value signal 31 and the angle value signal 322 and also provides the functions of displaying of the torque value and the angle value, alarming, and storage. In the first embodiment, the strain gauge 30, the angle sensor 32, and the information display unit 40 are connected to each other in a wired manner. The information display unit 40 is not limited to any specific form and in an embodiment of the present invention, the information display unit 40 comprises at least one amplifier 41, an analog-to-digital converter circuit 42, a microprocessor 43, a display interface 44, a display device 45, a backlight plate 46, a set of pushbuttons 47, an alarm device 48, and at least one power unit 49. The amplifier 41 is connected to the strain gauge 30 and the angle sensor 32 to receive and amplify the torque value signal 31 and the angle value signal 322. The analog-to-digital converter circuit 42 is connected to the amplifier 41 to convert the amplified torque value signal 31 and the angle value signal 322 into digital torque and angle data for output. The microprocessor 43 is connected to the analog-to-digital converter circuit 42 to receive the digital torque and angle data from the analog-to-digital converter circuit 42. The microprocessor 43 provides the operational functions of control of display of torque and angle values, setting of threshold torque value, alarming and storage of torque and angle values. The microprocessor 43 is also connected to a memory 431, which functions to store torque and angle values and preset threshold torque and angle value.

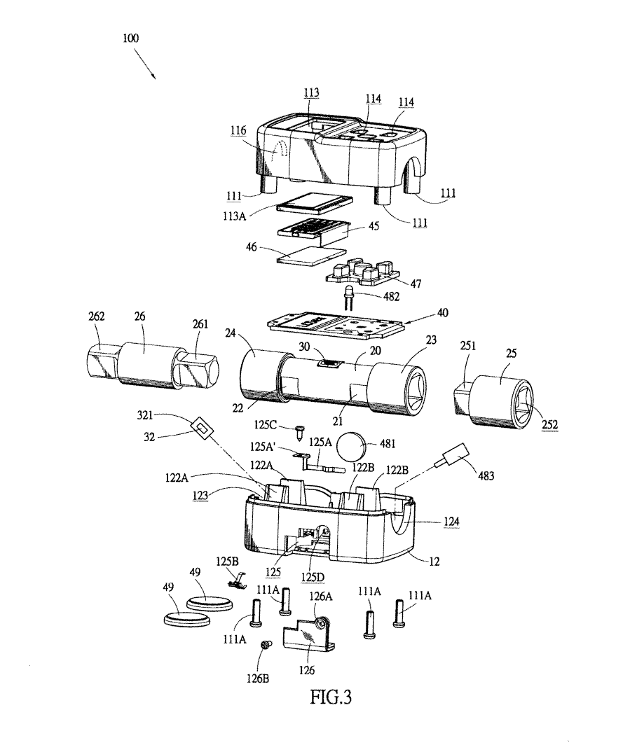

The display interface 44 is connected to the microprocessor 43 to convert the torque and angle data into a torque value display signal and an angle value display signal. The display device 45 is connected to the display interface 44 to process and then display the torque value display signal and the angle value display signal from the display interface 44. The display device 45 is not limited to any specific form and in an embodiment of the present invention, a liquid crystal display (LCD) is taken as an example of the display device 45. It is noted that other display devices, such as light-emitting diode (LED) based display devices, which show equivalent functions, are deemed within the scope of the present invention. The display device 45 is attached to the transparent panel 113A of the display window 113 of the first casing member 11 of the enclosure 10 (see FIG. 3).

The backlight plate 46 is connected to the microprocessor 43 and is arranged behind the display device 45 to provide backlighting to the display device 45.

The pushbuttons 47 are connected to the microprocessor 43 to provide manual access for the operation of the microprocessor 43 in respect of the functions of displaying, alarming, data input, and storage, including for example control and operation commands in connection with switching of units of the torque and angle values displayed, brightness of displaying light from the backlight plate 46, input of threshold torque/angle value for alarming, resetting of alarm, and storage of torque values. The pushbuttons 47 are arranged to respectively and partially project beyond the button openings 114 defined in the first casing member 11 of the enclosure 10 (see FIG. 3) for manual access and operation.

The alarm device 48 is connected to the microprocessor 43. When a detected value of torque or angle reaches a preset threshold torque value or a preset threshold angle value, the microprocessor 43 activates the alarm device 48 to give off sound and lighting alarms. The alarm device 48 is resettable by operating the pushbuttons 47 in order to shut down the sound and lighting alarms. The alarm device 48 is not limited to any specific form and in an embodiment of the present invention, the alarm device 48 comprises at least a sound alarm element 481, at least one lighting alarm element 482, and at least one vibration alarm element 483 (see FIG. 3). The sound alarm element 481 can be for example a buzzer or a loud speaker. The lighting alarm element 482 may comprise one or more light emitting diodes. The vibration alarm element 483 may comprise a miniature vibration motor. Thus, the sound alarm element 481, the lighting alarm element 482, and the vibration alarm element 483 may realize the functions of alarming with sound, lighting, and vibration. The sound alarm element 481 is arranged in the internal chamber 122 of the second casing member 12 of the enclosure 10. The lighting alarm element 482 is received and fixed in the alarm opening 115 of the first casing member 11 of the enclosure 10 to selectively show an alarm through the alarm opening 115. The vibration alarm element 483 is arranged inside the internal chamber 122 of the second casing member 12 to selectively induce electrically-actuated vibration on the first and second casing members 11, 12 for alarming.

The power unit 49 supplies a working power to the strain gauge 30, the angle sensor 32, the amplifier 41, the analog-to-digital converter circuit 42, the microprocessor 43, the display interface 44, the display device 45, the backlight plate 46, the pushbuttons 47, and the alarm device 48. The power unit 49 is not limited to any specific form, and in an embodiment of the present invention, a direct current (DC) battery is taken as an example of the power unit 49. The power unit 49 is received in the power compartment 125 of the second casing member 12 of the enclosure 10 with positive and negative terminals of the power unit 49 respectively set in engagement with the electrode plates 125A, 125B that are fixed inside the power compartment 125, whereby the electrode plates 125A, 125B supply electrical power from the positive and negative terminals of the power unit 49 to the strain gauge 30, the angle sensor 32, the amplifier 41, the analog-to-digital converter circuit 42, the microprocessor 43, the display interface 44, the display device 45, the backlight plate 46, the pushbuttons 47, and the alarm device 48.

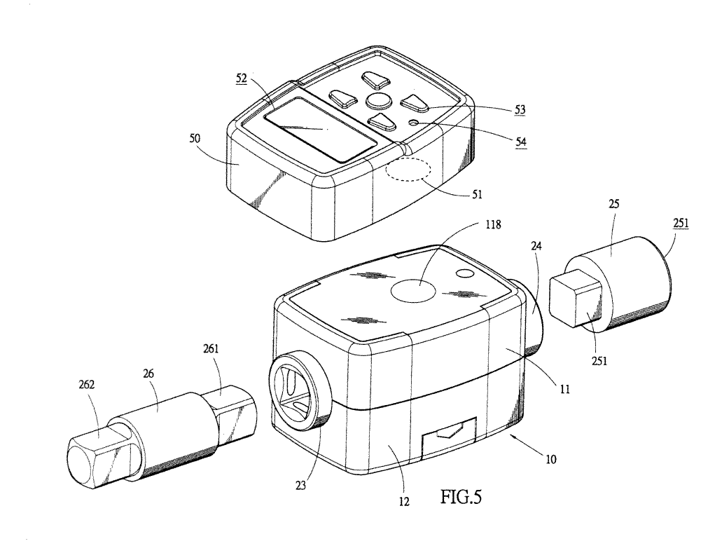

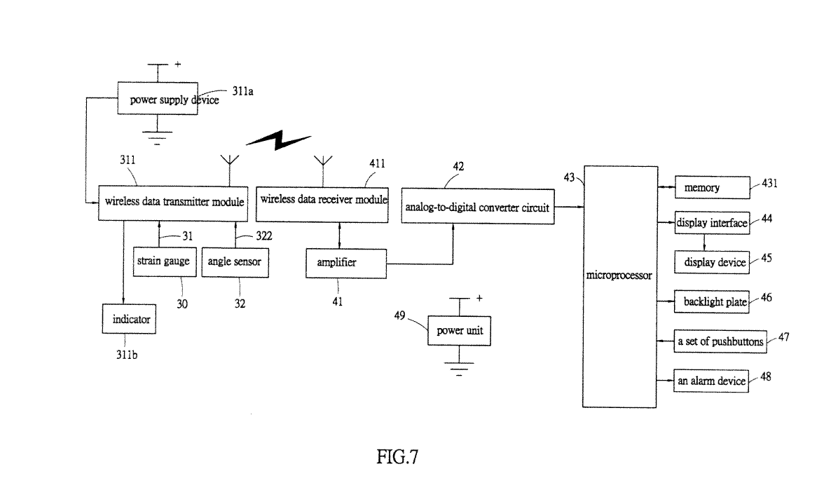

Referring to FIGS. 5-7, a multifunctional torque detection device constructed in accordance with a second embodiment of the present invention is shown, and is also designated with reference numeral 100 for simplicity. The coupling terminals 23, 24 of the ends of the toque-strain bar 20 respectively receive magnets 231, 241 in the recessed coupling bores thereof to provide magnetic attraction to the first raised coupling section 251 of the adaptor 25 and the second raised coupling section 261 of the coupler 26, whereby the adaptor 25 and the coupler 26 can be more securely and firmly coupled to the coupling terminals 23, 24 of the two ends of the toque-strain bar 20.

In addition, the strain gauge 30 and the angle sensor 32 are provided with at least one wireless data transmitter module 311, whereby the torque value signal 31 and the angle value signal 322 supplied from the strain gauge 30 and the angle sensor 32 can be transmitted in a wireless manner through the wireless data transmitter module 311. The wireless data transmitter module 311 is connected to a power supply device 311a and at least one indicator 311b, which respectively provide a working power to the wireless data transmitter module 311 and show a transmission status of the wireless data transmitter module 311. The power supply device 311a is not limited to any specific form, and in an embodiment of the present invention, a direct current (DC) battery is taken as an example of the power supply device 311a. An example of the indicator 311b is an LED.

The toque-strain bar 20, the strain gauge 30, the angle value signal 322, the wireless data transmitter module 311, and the power supply device 311a and the at least one indicator 311b are collectively arranged between the first casing member 11 and the second casing member 12 of the enclosure 10. The first casing member 11 further comprises at least one connection element 118. The connection element 118 is not limited to any specific form, and in an embodiment of present invention, a magnet is taken as an example of the connection element 118. However, it is noted that other connection elements that show an equivalent function, such as a hook-and-loop fastener or fitting socket, are deemed within the scope of the present invention in this respect.

The information display unit 40 is housed in an insulation casing 50. The insulation casing 50 has a bottom to which at least one mounting element 51 is attached. The mounting element 51 is not limited to any specific form, and in an embodiment of present invention, a magnet is taken as an example of the mounting element 51 for magnetically and releasably coupling to the connection element 118 of the first casing member 11. The insulation casing 50 forms, in a wall thereof, a display window 52, a plurality of button openings 53, and an alarm opening 54 respectively for installation of the display device 45 and the pushbuttons 47 of the information display unit 40 and the lighting alarm element 482 of the alarm device 48.

The amplifier 41 of the information display unit 40 is connected to at least one wireless data receiver module 411 that receives the torque value signal 31 and the angle value signal 322 transmitted, in a wireless manner, from the wireless data transmitter module 311 to the amplifier 41, whereby the amplifier 41 receives and amplifies the torque value signal 31 and the angle value signal 322. The subsequent operations of torque/angle value displaying, alarming, and storage are substantially identical to what described above with respect to information display unit 40 of FIG. 4 and repeated description is omitted. The toque-strain bar 20 and the strain gauge 30 can thus be selectively connected to or detached from the information display unit 40 through the releasable coupling between the connection element 118 and the mounting element 51 so that they can be used separately, wherein the transmission and reception of the torque value signal 31 and the angle value signal 322 are done in a wireless manner, making a torque device 200 and a tool piece 300 that are respectively coupled to the adaptor 25 and the coupler 26 connected to the coupling terminals 23, 24 of the toque-strain bar 20 operating in a constraint-free manner in tightening or loosening fasteners without being affected by any particular space or orientation of operation.

The wireless transmission and reception mode between the wireless data transmitter module 311 and the wireless data receiver module 411 is not limited to any specific mode and in an embodiment of the present invention, wireless radio frequency application is taken as an example. Other modes of wireless transmission and receipt modes, such as wireless USB (Universal Serial Bus), Blue Tooth, infrared, amplitude shift keying (ASK) or frequency shift keying (FSK), are deemed within the scope of the present invention.

Referring to FIGS. 8 and 9, an application of the multifunctional torque detection device 100 according to the present invention is illustrated. The coupling terminal 23 of the toque-strain bar 20 is connected to a tool coupling end 210 of a torque device 200 through the adaptor 25, and the coupling terminal 24 is connected to a fitting bore 310 of a tool piece 300 through the coupler 26. The torque device 200 can be for example a hand tool, an electrical tool, or a pneumatic tool, which functions as a device that generates a torque source. In an embodiment of the present invention, a torque wrench is taken as an example of the torque device 200, and an example of the tool piece 300 is a wrench socket.

The operation of the torque device 200 provides a twisting torque to drive the tool piece 300 for tightening or loosening for example a nut. During the operation, the strain gauge 30 mounted to the toque-strain bar 20 detects and provides an output of the torque generated by the operation of the torque device 200 as a torque value signal 31 to the information display unit 40 and the angle sensor 32 provides an angle value 322 to the information display unit 40, both being done in either a wired manner or a wireless manner as discussed above. Thus, based on the torque value signal 31 and the angle value signal 322, the information display unit 40 selectively proceeds with desired operations of displaying, alarming, and storage. In other words, the torque value and the angle value are displayed on the display device 45, and when the torque value and/or the angle value reaches a threshold set in advance by a user, the sound alarm element 481, the lighting alarm element 482, and the vibration alarm element 483 of the alarm device 48 respectively give off sound alarms, lighting alarms, and vibration alarms to allow the user to be timely notified of the alarm and to adjust the torque or operation angle applied by the torque device 200.

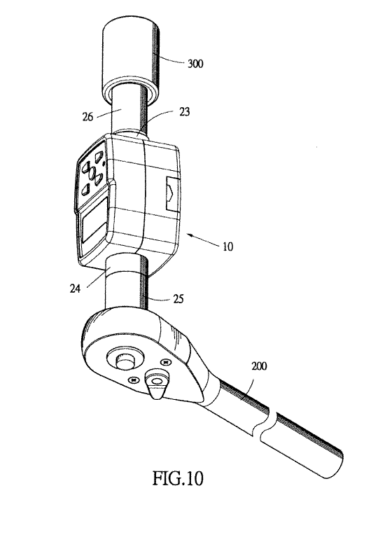

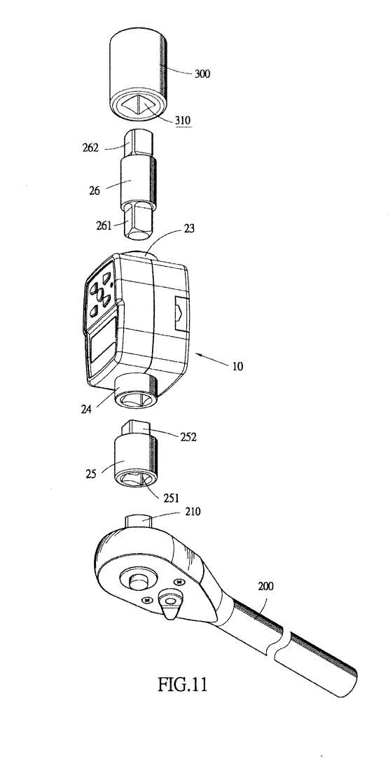

Referring to FIGS. 10 and 11, another application of the multifunctional torque detection device 100 according to the present invention is illustrated, wherein the direction of arrangement and operation of the torque device 200 and the tool piece 300 are exactly opposite to (namely reversed by 180 degrees) what shown in FIGS. 8 and 9. The coupling terminals 23, 24 of the toque-strain bar 20 allow the adaptor 25 to which the torque device 200 is coupled and the coupler 26 to which the tool piece 300 is coupled to be connected to the toque-strain bar 20 in a reversed manner. In this way, the display device 45 of the information display unit 40 can be maintained at a correct direction to allow the readings of torque and angle to be easily and readily inspected by a user.

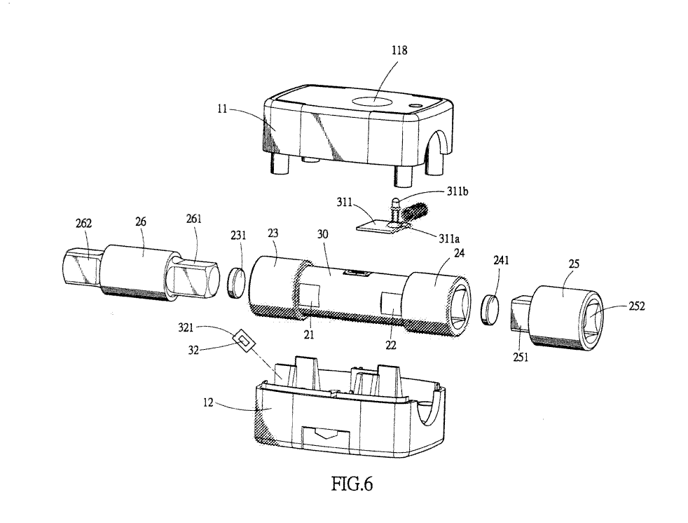

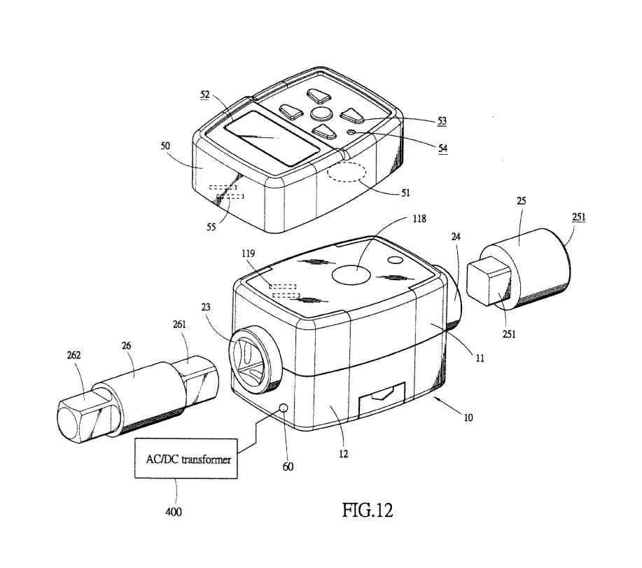

Referring to FIG. 12, which shows a multifunctional torque detection device constructed in accordance with a third embodiment of the present invention, the multifunctional torque detection device of the third embodiment, which is also designated with reference numeral 100, comprises a structure similar to that shown in FIGS. 5 and 6, but the enclosure 10 forms at least one charging connector 60 and the first casing member 11 is provided with a plurality charging contacts 119. The charging connector 60 is connectable to an external power transformer 400 to receive a desired direct current therefrom. The charging contacts 119 and the power supply device 311a are electrically connected to the charging connector 60 to receive power therefrom. Further, the insulation casing 50 that houses the information display unit 40 forms, in a bottom thereof, a plurality of charging pads 55 that is connected to the power unit, whereby when the insulation casing 50 is attached to the first casing member 11 of the enclosure 10 through the coupling between the mounting element 51 and the connection element 118, the charging pads 55 are respectively set to correspond to and engage the charging contacts 119 to allow the direct current from the charging connector 60 to be charged to the power unit 49. In other words, the power supply device 311a and the power unit 49 can be charged simultaneously.

The multifunctional torque detection devices as described above with reference to FIGS. 1-12 provide illustrative examples of the technical solution and measures taken by the present invention and it is noted that the idea of the present invention can be embodied in different forms and is not limited to the description given above. Thus, although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A multifunctional torque detection device, comprising:
an enclosure, which forms an internal chamber and having opposite side walls each defining a passage;
at least one toque-strain bar, which is received in the internal chamber of the enclosure and has opposite end sections forming coupling terminals respectively received through the passages defined in the opposite side walls of the enclosure to project outside the enclosure for selectively receiving an external torque and coupling with tool piece to which the torque is to be applied;
at least one adaptor, which has opposite ends respectively forming a first raised coupling section and a recessed coupling cavity, the first raised coupling section being selectively coupleable with a first one of the coupling terminals of the toque-strain bar, the recessed coupling cavity being adapted to connect to a tool coupling end of a torque device;
at least one coupler, which has opposite ends respectively forming a second raised coupling section and a third raised coupling section, the second raised coupling section being selectively coupleable with a second one of the coupling terminals of the toque-strain bar, the third raised coupling section being adapted to connect to a fitting bore of the tool piece;
at least one strain gauge, which is directly mounted to a surface of the toque-strain bar to detect the torque applied to the toque-strain bar and to convert the torque into a torque value signal;
at least one angle sensor, which is mounted inside the enclosure to detect a horizontal angle of the torque-strain bar and the enclosure and to convert the detected angle into an angle value signal; and
at least one information display unit, which is received in the internal chamber of the enclosure and is connected to the strain gauge and the angle sensor to receive the torque value signal and the angle value signal for performing displaying of torque value and angle value, alarming, and storage in respect of the torque value signal and the angle value signal.

2. The multifunctional torque detection device as claimed in claim 1, wherein the enclosure comprises a first casing member and a second casing member mating each other.

3. The multifunctional torque detection device as claimed in claim 2, wherein the first casing member and the second casing member both form an internal space therein.

4. The multifunctional torque detection device as claimed in claim 1, wherein the angle sensor comprises a gyro integrated circuit.

5. The multifunctional torque detection device as claimed in claim 1, wherein the information display unit comprises:
at least one amplifier, which is connected to the strain gauge and the angle sensor to receive and amplify the torque value signal and the angle value signal;
at least one analog-to-digital converter circuit, which is connected to the amplifier to convert the torque value signal and the angle value signal that are amplified by the amplifier into digital data;
at least one microprocessor, which is connected to the analog-to-digital converter circuit to receive the digital data of torque and angle from the analog-to-digital converter circuit, the microprocessor providing functions of control of display of torque and angle, setting threshold values of torque and angle, alarming in respect of torque and angle, and storage of torque and angle;
at least one display interface, which is connected to the microprocessor to convert the data of torque and angle into torque and angle value display signals;
at least one display device, which is connected to the display interface to process and then display the torque and angle value display signals from the display interface;
at least one backlight plate, which is connected to the microprocessor to provide backlighting to the display device;
at least one group of pushbuttons, which is connected to the microprocessor to provide manual access for operations of the microprocessor in respect of displaying, alarming, data input, and storage;
at least one alarm device, which is connected to the microprocessor to be actuated by the microprocessor to give off sound and lighting alarms at the time when a detected value of torque and/or angle reaches a preset threshold value of torque and/or angle; and
at least one power unit, which supplies working power to the strain gauge, the angle sensor, the amplifier, the analog-to-digital converter circuit, the microprocessor, the display interface, the display device, the backlight plate, the pushbuttons, and the alarm device

6. The multifunctional torque detection device as claimed in claim 5, wherein the microprocessor is connected to a memory.

7. The multifunctional torque detection device as claimed in claim 5, wherein the display device comprises a liquid crystal display.

8. The multifunctional torque detection device as claimed in claim 5, wherein the backlight plate is arranged behind the display device.

9. The multifunctional torque detection device as claimed in claim 5, wherein the alarm device comprises at least one sound alarm element, at least one lighting alarm element, and at least one vibration alarm element.

10. The multifunctional torque detection device as claimed in claim 9, wherein the sound alarm element comprises a buzzer.

11. The multifunctional torque detection device as claimed in claim 9, wherein the sound alarm element comprises a loud speaker.

12. The multifunctional torque detection device as claimed in claim 9, wherein the lighting alarm element comprises a light-emitting diode.

13. The multifunctional torque detection device as claimed in claim 9, wherein the vibration alarm element comprises a miniature vibration motor.

14. The multifunctional torque detection device as claimed in claim 5, wherein the power unit comprises a direct current battery.

15. A multifunctional torque detection device, comprising:
an enclosure, which forms an internal chamber and having opposite side walls each defining a passage;
at least one toque-strain bar, which is received in the internal chamber of the enclosure and has opposite end sections forming coupling terminals respectively received through the passages defined in the opposite side walls of the enclosure to project outside the enclosure for selectively receiving an external torque and coupling with tool piece to which the torque is to be applied;
at least one adaptor, which has opposite ends respectively forming a first raised coupling section and a recessed coupling cavity, the first raised coupling section being selectively coupleable with a first one of the coupling terminals of the toque-strain bar, the recessed coupling cavity being adapted to connect to a tool coupling end of a torque device;
at least one coupler, which has opposite ends respectively forming a second raised coupling section and a third raised coupling section, the second raised coupling section being selectively coupleable with a second one of the coupling terminals of the toque-strain bar, the third raised coupling section being adapted to connect to a fitting bore of the tool piece;
at least one strain gauge, which is directly mounted to a surface of the toque-strain bar to detect the torque applied to the toque-strain bar and to convert the torque into a torque value signal, the strain gauge being connected to at least one wireless data transmitter module that transmits the torque value signal in a wireless manner;
at least one angle sensor, which is mounted inside the enclosure to detect a horizontal angle of the torque-strain bar and the enclosure and to convert the detected angle into an angle value signal, the angle sensor being also connected to the wireless data transmitter module; and
at least one information display unit, which is housed in an insulation casing, the information display unit being connected to at least one wireless data receiver module that receives the torque value signal and the angle value signal from the wireless data transmitter module in a wireless manner to allow the information display unit to perform displaying of torque value and angle value, alarming, and storage in respect of the torque value signal and the angle value signal.

16. The multifunctional torque detection device as claimed in claim 15, wherein the first casing member of the enclosure comprises at least one connection element.

17. The multifunctional torque detection device as claimed in claim 16, wherein the connection element comprises a magnet.

18. The multifunctional torque detection device as claimed in claim 15, wherein the first casing member of the enclosure forms a plurality of charging contacts.

19. The multifunctional torque detection device as claimed in claim 15, wherein the enclosure forms a charging connector,

20. The multifunctional torque detection device as claimed in claim 15, wherein the wireless data transmitter module connected to the strain gauge and the angle sensor is connected to at least one power supply device and at least one indicator.

21. The multifunctional torque detection device as claimed in claim 15, wherein the insulation casing of the information display unit has a bottom forming a plurality of charging pads.

22. The multifunctional torque detection device as claimed in claim 15, wherein the information display unit comprises:
at least one amplifier, which is connected to the wireless data receiver module that receives the torque value signal and the angle value signal in a wireless manner, in order to receive and amply the torque value signal and the angle value signal;
at least one analog-to-digital converter circuit, which is connected to the amplifier to convert the torque value signal and the angle value signal that are amplified by the amplifier into digital data of torque and angle;
at least one microprocessor, which is connected to the analog-to-digital converter circuit to receive the digital data of torque and angle from the analog-to-digital converter circuit, the microprocessor providing functions of control of display of torque and angle, setting threshold values of torque and angle, alarming in respect of torque and angle, and storage of torque and angle;
at least one display interface, which is connected to the microprocessor to convert the data of torque and angle into a torque and angle value display signals;
at least one display device, which is connected to the display interface to process and then display the torque and angle value display signals from the display interface;
at least one backlight plate, which is connected to the microprocessor to provide backlighting to the display device;
at least one group of pushbuttons, which is connected to the microprocessor to provide manual access for operations of the microprocessor in respect of displaying, alarming, data input, and storage;
at least one alarm device, which is connected to the microprocessor to be actuated by the microprocessor to give off sound and lighting alarms at the time when a detected value of torque and/or angle reaches a preset threshold value of torque and/or angle; and
at least one power unit, which supplies working power to the strain gauge, the angle sensor, the amplifier, the analog-to-digital converter circuit, the microprocessor, the display interface, the display device, the backlight plate, the pushbuttons, and the alarm device.
